(19) United States
(12) Patent Application Publication
(10) Pub. No.: US 2016/0077545 A1
(43) Pub. Date: Mar. 17, 2016

(54) POWER AND PERFORMANCE MANAGEMENT OF ASYNCHRONOUS TIMING DOMAINS IN A PROCESSING DEVICE

(71) Applicant: Advanced Micro Devices, Inc., Sunnyvale, CA (US)

(72) Inventors: Wayne P. Burleson, Shutesbury, MA (US); Manish Arora, Dublin, CA (US); Indrani Paul, Round Rock, TX (US); Yasuko Eckert, Kirkland, WA (US)

(21) Appl. No.: 14/489,130

(22) Filed: Sep. 17, 2014

(51) Int. Cl. G06F 1/08; G06F 1/26

(52) U.S. Cl. CPC G06F 1/08; G06F 1/26

(57) ABSTRACT

A processing device includes a producing processor unit in a first timing domain and a consuming processor unit in a second timing domain that is asynchronous with the first timing domain. A queue is used to convey data between the producing processor unit and the consuming processor unit. A system management unit is to modify one or both of an operating frequency or an operating voltage of one or both of the producing processor unit or the consuming processor unit based on a rate of change of a fullness of the queue.

### CROSS REFERENCE TO RELATED APPLICATIONS

This application is related to U.S. patent application Ser. No. ______ (Attorney Docket No. 1458-130193), entitled “FREQUENCY CONFIGURATION OF ASYNCHRONOUS TIMING DOMAINS UNDER POWER CONSTRAINTS” and filed on even date herewith, the entirety of which is incorporated by reference herein.

### BACKGROUND

1. Field of the Disclosure

The present disclosure relates generally to processing devices and, more particularly, to asynchronous timing domains in a processing device.

2. Description of the Related Art

Components in conventional processing devices have traditionally been synchronized to a single global clock. For example, the same global clock signal may be provided to a central processing unit (CPU), a graphics processing unit (GPU), an accelerated processing unit (APU), or other entities in the processing device. Motivated in part by a demand for more efficient use of power in processing devices, processing devices are being designed with multiple timing domains that synchronize to different clock frequencies. For example, a different voltage may be supplied to each processor core in a CPU and the operating frequencies of the processor cores may therefore differ. For another example, the CPUs, the GPUs, or the APUs in a processing device may be implemented in different timing domains that synchronize to different clocks that run at different frequencies. The different timing domains may also use different operating voltages. Conventional processing devices typically set the operating frequencies and operating voltages in the different timing domains to values predetermined by a power profile.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device according to some embodiments.

FIG. 2 shows a plot of a fullness of a queue that buffers data between a consuming processor unit in a first timing domain and a producing processor unit in a second timing domain according to some embodiments.

FIG. 3 shows a plot of a fullness of a queue that buffers data between a consuming processor unit in a first timing domain and a producing processor unit in a second timing domain according to some embodiments.

FIG. 4 is a flow diagram of a method that may be used to avert overflow of a queue between a consuming processor unit in a first timing domain and a producing processor unit in a second timing domain according to some embodiments.

FIG. 5 is a flow diagram of a method that may be used to avert underflow of a queue between a consuming processor unit in a first timing domain and a producing processor unit in a second timing domain according to some embodiments.

FIG. 6 is a flow diagram illustrating a method for designing and fabricating an integrated circuit device implementing at least a portion of a component of a processing system in accordance with some embodiments.

### DETAILED DESCRIPTION

Components in asynchronous timing domains of a processing device may produce or consume data at different rates because they operate at different voltages or frequencies. Thus, a producing component may generate data faster or slower than a consuming component can process, or “consume,” the data generated by the producing component. Queues may therefore be used to buffer data that is being transmitted between a producing component and a consuming component. For example, a queue may be implemented between a CPU and a GPU to buffer data that is produced by the CPU for subsequent consumption (e.g., rendering and display) by the GPU. However, the queue may overflow or underflow if a mismatch between the rate of production of the data and the rate of consumption of the data becomes too large. The mismatch may be caused by differences between the operating voltages and frequencies in the asynchronous timing domains that include the CPU and the GPU. Overflow may result in the loss of data and underflow may result in degradation in performance due to delays caused by waiting for data to fill an empty queue.

Overflow or underflow of queues used to buffer data that is conveyed between components in asynchronous timing domains of a processing device may be reduced or eliminated by monitoring a fullness of the queue and adjusting an operating voltage or operating frequency of at least one of the timing domains based on a rate of change of the fullness of the queue. For example, the operating voltage or operating frequency of a consuming component may be increased when the fullness is above a threshold fullness or the fullness of the queue is increasing at a rate that is above a threshold rate and (additionally or alternatively) an operating voltage or operating frequency of the producing component may be decreased when the fullness is above the threshold fullness or the fullness of the queue is increasing at a rate above the threshold rate. For another example, the operating voltage or operating frequency of the consuming component may be decreased (or, additionally or alternatively, the operating voltage or operating frequency of the producing component increased) when the fullness is below a threshold fullness or the fullness of the queue is decreasing at a rate that is below another threshold rate. In some embodiments, the threshold rates may be adjusted based upon the fullness of the queue or vice versa. For example, the threshold rate used to decide when to slow down the consuming component or speed up the producing component may be set to a relatively low value when the fullness of the queue is low (and buffer underflow is more likely) and may be set to a relatively high value when the fullness of the queue is high (and buffer underflow is less likely).

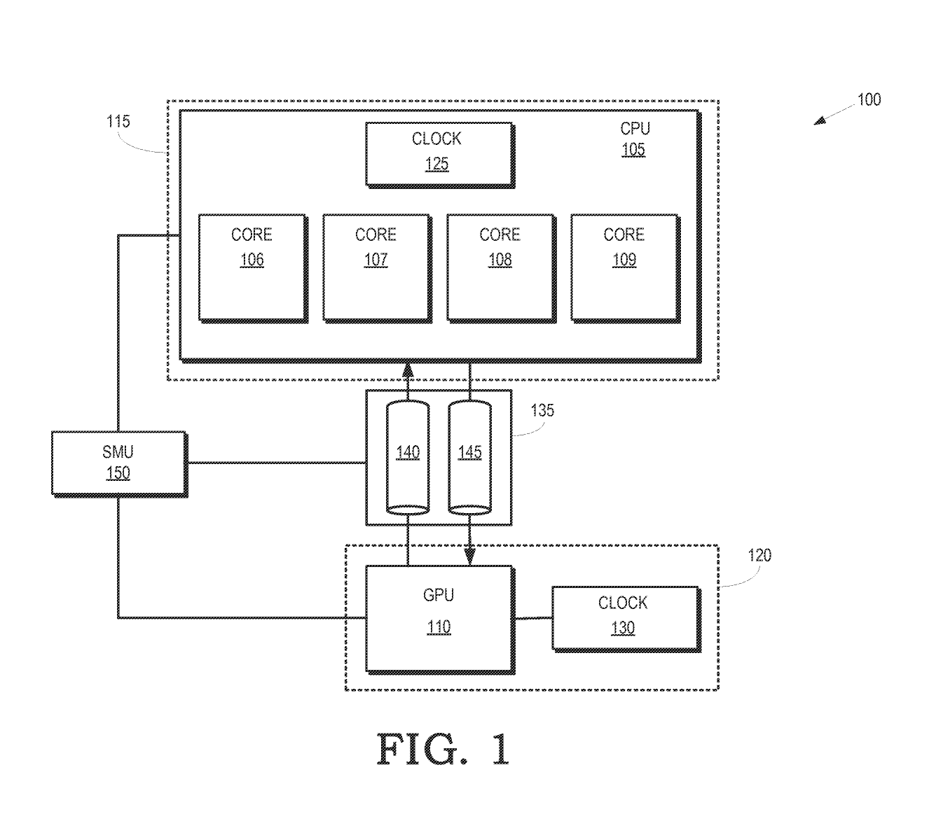

FIG. 1 is a block diagram of a processing device 100 according to some embodiments. The processing device 100 includes a central processing unit (CPU) 105 for executing instructions. Some embodiments of the CPU 105 include multiple processor cores 106, 107, 108, 109 (collectively referred to as “the processor cores 106-109”) that can independently execute instructions concurrently or in parallel. The CPU 105 shown in FIG. 1 includes four processor cores 106-109. Persons of ordinary skill in the art having benefit of the present disclosure should appreciate that the number or size of processor cores in the CPU 105 is a matter of design choice. Some embodiments of the CPU 105 may include more or fewer than the four processor cores 106-109 shown in FIG. 1

A graphics processing unit (GPU) 110 is also included in the processing device 100 for creating visual images intended for output to a display, e.g., by rendering the images on a display at a frequency determined by a rendering rate. Some embodiments of the GPU 110 may include multiple cores, a video frame buffer, or cache elements that are not shown in FIG. 1 interest of clarity.

The processing device 100 implements multiple timing domains 115, 120. As used herein, the term “timing domain” refers to a portion of the processing device 100 that uses a clock signal that is independent of one or more clock signals that are used by portions of the processing device 100 that are outside of the timing domain, e.g., portions of the processing device 100 that are in other timing domains. Some embodiments of the timing domains 115, 120 therefore include independent clocks 125, 130 that provide different clock signals to the circuitry in the timing domains 115, 120. The clock signals may be generated at different nominal clock frequencies. For example, the clock signal used within the timing domain 115 may be generated by a clock 125 that operates at a nominal frequency of 1 GHz and the clock 130 may provide a clock signal at a nominal frequency of 4 GHz to be used within the timing domain 120.

The operating frequencies of the clocks 125, 130 may differ from their nominal frequencies. For example, increasing the operating voltage of the clocks 125, 130 may increase their operating frequencies relative to their nominal frequencies and decreasing the operating voltages of the clocks 125, 130 may decrease their operating frequencies relative to their nominal frequencies. The frequencies of the clocks 125, 130 used in the timing domains 115, 120 may therefore be independently controlled or modified based on the operating voltages applied to the timing domains 115, 120. For example, the operating voltage in the timing domain 115 may be increased relative to the operating voltage used in the timing domain 120 to increase the operating frequency of the clock 125 relative to its nominal frequency or relative to the operating or nominal frequency of the clock 130.

Components in the different timing domains 115, 120 may communicate by exchanging signals or data via buffer circuitry 135. Some embodiments of the buffer circuitry 135 include queues 140, 145 for buffering data that is being conveyed between the timing domains 115, 120. For example, the buffer circuitry 135 may include a first-in-first-out (FIFO) queue 140 (or other type of queue) that receives data from the timing domain 120 that includes the GPU 110 and holds the data until it is requested by the timing domain 115, e.g., in response to a request from the CPU 105 or one of the processor cores 106-109. In this example, the GPU 110 may be referred to as the producing processor unit and the CPU 105 (or one of the processor cores 106-109) may be referred to as the consuming processor unit. For another example, the buffer circuitry 135 may include a FIFO queue 145 (or other type of queue) that receives data from the timing domain 115 and holds the data until it is requested by the timing domain 120, e.g., in response to a request from the GPU 110. In this example, the CPU 105 (or one of the processor cores 106-109) may be referred to as the producing processor unit and the GPU 110 may be referred to as the consuming processor unit.

The processing device 100 may implement a system management unit (SMU) 150 that may be used for performance management or power management. Some embodiments of the SMU 150 may be implemented in software, firmware, or hardware and may be implemented outside of the timing domains 115, 120 as shown in FIG. 1. The SMU 150 can monitor the state of the buffer circuitry 135. For example, the SMU 150 may be able to monitor the fullness of the FIFO queues 140, 145 by measuring the fullness continuously or at predetermined time intervals or time steps. The SMU 150 may also be able to calculate the rate of change of the fullness of the FIFO queues 140, 145, e.g., by calculating differences between the measured fullnesses at different time intervals. Other information associated with the FIFO queue 140, 145 may also be available to the SMU 150. For example, the SMU 150 may have access to information indicating sizes of the FIFO queues 140, 145 and an indication of the amount of time that may be required to change the operating voltage or operating frequency in the timing domains 115, 120.

As discussed herein, mismatches between the operating voltage, operating frequency, or nominal frequencies of the clock signals used in the timing domains 115, 120 may cause one or more of the FIFO queues 140, 145 to overflow or underflow. The SMU 150 may therefore modify the operating voltage or operating frequency of the producing processor unit or the consuming processor unit based on the measured fullnesses, the rate of change of the fullnesses, the size of the queue, the predetermined time interval, or the time that may be needed to change the operating voltage or operating frequency of the producing processor unit or the consuming processor unit. For example, the SMU 150 may use the measured fullness, the rate of change of the fullness, and the size of the queue to estimate how long it may take for the buffer to underflow or overflow if the current values of these quantities are maintained. The SMU 150 may then take action to prevent an underflow or overflow if the estimated time to underflow or overflow is a predetermined multiple of the time that may be needed to change the operating voltage or operating frequency of the producing processor unit or the consuming processor unit. Thus, the SMU 150 may predict when an underflow or overflow may occur so that it may take action prior to the underflow or overflow.

Although two timing domains 115, 120 and the buffer circuitry 135 are shown in FIG. 1, some embodiments of the processing device 100 may include more than two timing domains that are interconnected by additional buffer circuitry that may include additional queues. The SMU 150 may be able to monitor fullnesses, rates of change of fullnesses, sizes of queues, predetermined time intervals, or times required to change the operating voltages or operating frequencies for the additional timing domains or buffer circuitry. The SMU 150 may also be able to concurrently predict underflow or overflow conditions in the additional queues and concurrently determine operating voltages or operating frequencies in one or more of the timing domains to avert or prevent the predicted underflow or overflow conditions. The number of timing domains and design of the buffer circuitry that interconnects the timing domains is a matter of design choice.

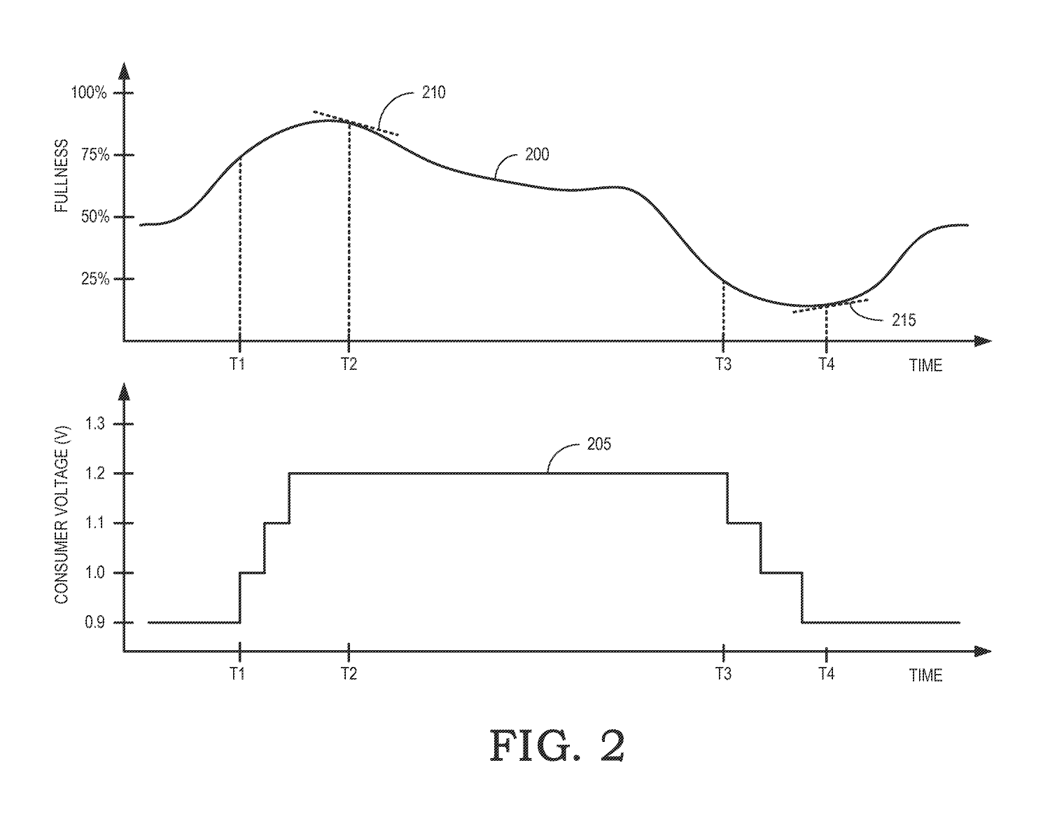

FIG. 2 shows a plot 200 of a fullness of a queue that buffers data between a consuming processor unit in a first timing domain and a producing processor unit in a second timing domain according to some embodiments. The vertical axis indicates the fullness of the queue and the horizontal axis indicates time (in arbitrary units) increasing from left to right. A plot 205 indicates a voltage (in volts) provided to a timing domain that includes the consuming processor unit. The vertical axis indicates the consumer voltage and the horizontal axis indicates time increasing from left to right.

At T<T1, the fullness of the queue is increasing from approximately 50% to approximately 75%. The rise in the fullness of the queue may be due to a mismatch between the operating voltages or operating frequencies in the timing domains that host the consuming processor unit and the producing processor unit. For example, the consuming processor unit may be operating at a low voltage or frequency (relative to the producing processor unit) so that the consuming processor unit is not able to consume data as rapidly as the producing processor unit is able to produce the data and provide the data to the queue.

At T=T1, the fullness of the queue rises above a threshold value of 75%. A system management unit such as the SMU 150 shown in FIG. 1 may be monitoring the fullness and may therefore trigger a change in the operating voltage of the consuming processor unit to prevent overflow due to the rise in the fullness. The threshold value of the fullness may be a predetermined value or it may be determined based on a concurrent rate of change of the fullness, a size of the queue, a time that may be needed to change the operating voltage or operating frequency of the consuming processor unit, or other characteristics associated with the queue.

At T1<T<T2, the fullness of the queue continues to rise above the threshold value of 75% and so the SMU increases the operating voltage to attempt to increase the data consumption rate at the consuming processor unit. For example, the SMU may increase the operating voltage in increments from 0.9 V to 1.0 V to 1.1 V to 1.2 V.

At T=T2, the rate of change of the fullness of the queue becomes negative, as indicated by the line 210, which indicates that the fullness of the queue is decreasing. Since the danger of overflow has been averted, the SMU maintains the operating voltage at the current value of 1.2 V. Although in this example the rate of change of the fullness is used to determine when to bypass further increases in the operating voltage, the SMU may also decide when to bypass further increases based on other information including the fullness, the size of the queue, the time to change the operating voltage of the consuming processor unit, or other characteristics associated with the queue.

At T2<T<T3, the fullness of the queue decreases from about 75% to approximately 25%. The decrease in the fullness may be due to a mismatch between the operating voltages or frequencies in the timing domains that results in a mismatch in the rate of consumption of data at the consuming processor unit and the rate of production of data at the producing processor unit. The consuming processor unit is therefore consuming data from the queue faster than the producing processor unit can produce the data.

At T=T3, the fullness of the queue falls below approximately 25%. The SMU may therefore attempt to prevent an underflow by triggering a decrease in the operating voltage of the consuming processor unit to attempt to decrease the rate at which the consuming processor unit consumes data. The threshold value of the fullness may be a predetermined value or it may be determined based on a concurrent rate of change of the fullness, a size of the queue, a time that may be needed to change the operating voltage or operating frequency of the consuming processor unit, or other characteristics associated with the queue.

At T3<T<T4, the fullness of the queue continues to fall below the threshold value of 25% and so the SMU continues to decrease the operating voltage to attempt to decrease the data consumption rate at the consuming processor unit. For example, the SMU may decrease the operating voltage in increments from 1.2 V to 1.1 V to 1.0 V to 0.9 V.

At T=T4, the rate of change of the fullness of the queue becomes positive, as indicated by the line 215, which indicates that the fullness of the queue is increasing. Since the danger of underflow has been averted, the SMU maintains the operating voltage at the current value of 0.9 V. Although in this example the rate of change of the fullness is used to determine when to bypass further decreases in the operating voltage, the SMU may also decide to bypass further decreases based on other information including the fullness, the size of the queue, the time to change the operating voltage of the consuming processor unit, or other characteristics associated with the queue.

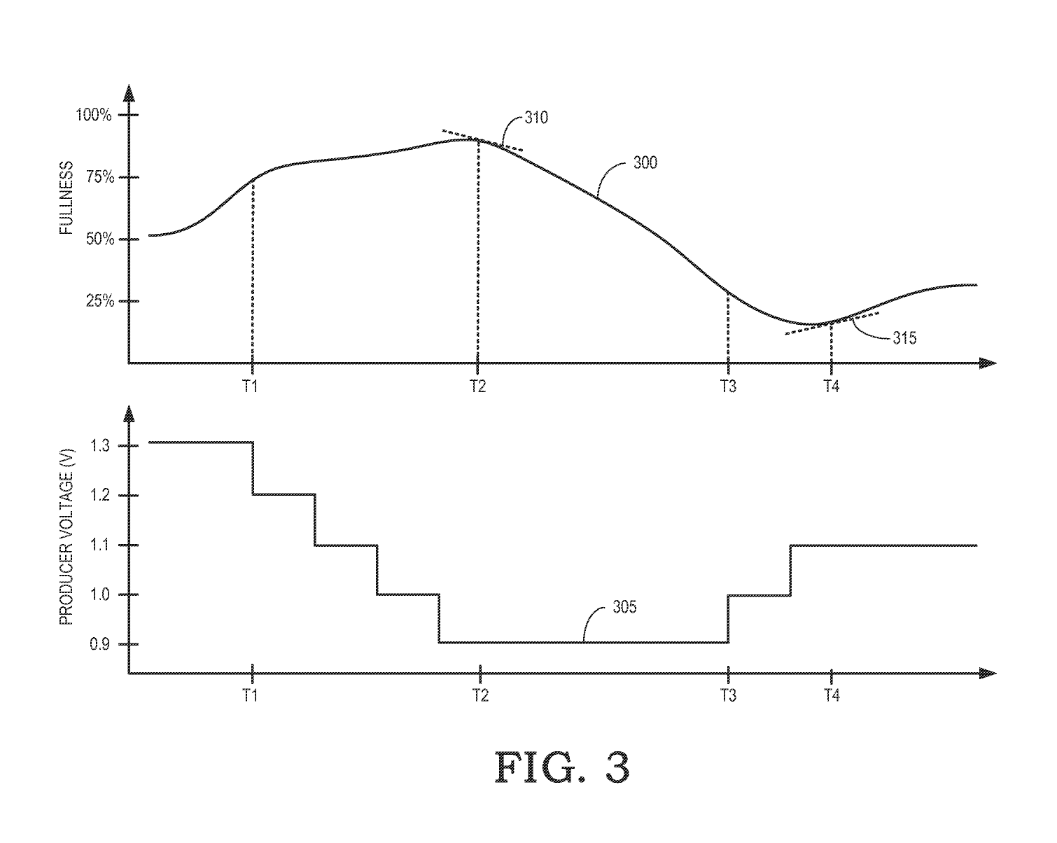

FIG. 3 shows a plot 300 of a fullness of a queue that buffers data between a consuming processor unit in a first timing domain and a producing processor unit in a second timing domain according to some embodiments. The vertical axis indicates the fullness of the queue and the horizontal axis indicates time (in arbitrary units) increasing from left to right. A plot 305 indicates a voltage (in volts) provided to a timing domain that includes the producing processor unit. The vertical axis indicates the producer voltage and the horizontal axis indicates time increasing from left to right.

At T<T1, the fullness of the queue is increasing from approximately 50% to approximately 75%. The rise in the fullness of the queue may be due to a mismatch between the operating voltages or operating frequencies in the timing domains that host the consuming processor unit and the producing processor unit. For example, the producing processor unit may be operating at a high voltage or frequency (relative to the consuming processor unit) so that the producing processor unit is producing data and providing it to the queue faster than the consuming processor unit can consume the data from the queue.

At T=T1, the fullness of the queue rises above a threshold value of 75%. A system management unit such as the SMU 150 shown in FIG. 1 may be monitoring the fullness and may therefore trigger a change in the operating voltage of the producing processor unit to prevent overflow due to the rise in the fullness. The threshold value of the fullness may be a predetermined value or it may be determined based on a concurrent rate of change of the fullness, a size of the queue, a time that may be needed to change the operating voltage or operating frequency of the consuming processor unit, or other characteristics associated with the queue.

At T1<T<T2, the fullness of the queue continues to rise above the threshold value of 75% and so the SMU decreases the operating voltage to attempt to decrease the data production rate at the producing processor unit. For example, the SMU may decrease the operating voltage in increments from 1.3 V to 1.2 V to 1.1 V to 1.0 V to 0.9 V.

At T=T2, the rate of change of the fullness of the queue becomes negative, as indicated by the line 310, which indicates that the fullness of the queue is decreasing. Since the danger of overflow has been averted, the SMU maintains the operating voltage of the producing processor unit at the current value of 0.9 V. Although in this example the rate of change of the fullness is used to determine when to bypass further increases in the operating voltage, the SMU may also decide to bypass further increases based on other information including the fullness, the size of the queue, the time to change the operating voltage of the consuming processor unit, or other characteristics associated with the queue.

At T2<T<T3, the fullness of the queue decreases from about 75% to approximately 25%. The decrease in the fullness may be due to a mismatch between the operating voltages or frequencies in the timing domains that results in a mismatch in the rate of consumption of data at the consuming processor unit and the rate of production of data at the producing processor unit. Because of the mismatch, the producing processor unit is not producing data as fast as the consuming processor unit can consume the data from the queue.

At T=T3, the fullness of the queue falls below approximately 25%. The SMU may therefore attempt to prevent an underflow by triggering an increase in the operating voltage of the producing processor unit to attempt to increase the rate at which the producing processor unit produces data. The threshold value of the fullness may be a predetermined value or it may be determined based on a concurrent rate of change of the fullness, a size of the queue, a time that may be needed to change the operating voltage or operating frequency of the consuming processor unit, or other characteristics associated with the queue.

At T3<T<T4, the fullness of the queue continues to fall below the threshold value of 25% and so the SMU increases the operating voltage to attempt to increase the data production rate at the producing processor unit. For example, the SMU may increase the operating voltage in increments from 0.9 V to 1.0 V to 1.1 V.

At T=T4, the rate of change of the fullness of the queue becomes positive, as indicated by the line 315, which indicates that the fullness of the queue is increasing. Since the danger of underflow has been averted, the SMU maintains the operating voltage of the producing processor unit at the current value of 1.1 V. Although in this example the rate of change of the fullness is used to determine when to bypass further increases in the operating voltage, the SMU may also decide to bypass further increases based on other information including the fullness, the size of the queue, the time to change the operating voltage of the consuming processor unit, or other characteristics associated with the queue.

The embodiments depicted in FIG. 2 and FIG. 3 describe modifications to the operating voltage of the consuming processor unit and the producing processor unit, respectively. However, in some embodiments, the operating voltages of both the consuming processor unit and the producing processor unit may be concurrently modified to address mismatches in the production and consumption rates and to avert overflow or underflow conditions. For example, the operating voltage of the consuming processor unit may be increased concurrently with decreasing the operating voltage of the producing processor unit to slow or reverse increases in the fullness of a queue between the consuming processor unit and the producing processor unit. For another example, the operating voltage of the consuming processor unit may be decreased concurrently with increasing the operating voltage of the producing processor unit to slow or reverse decreases in the fullness of the queue.

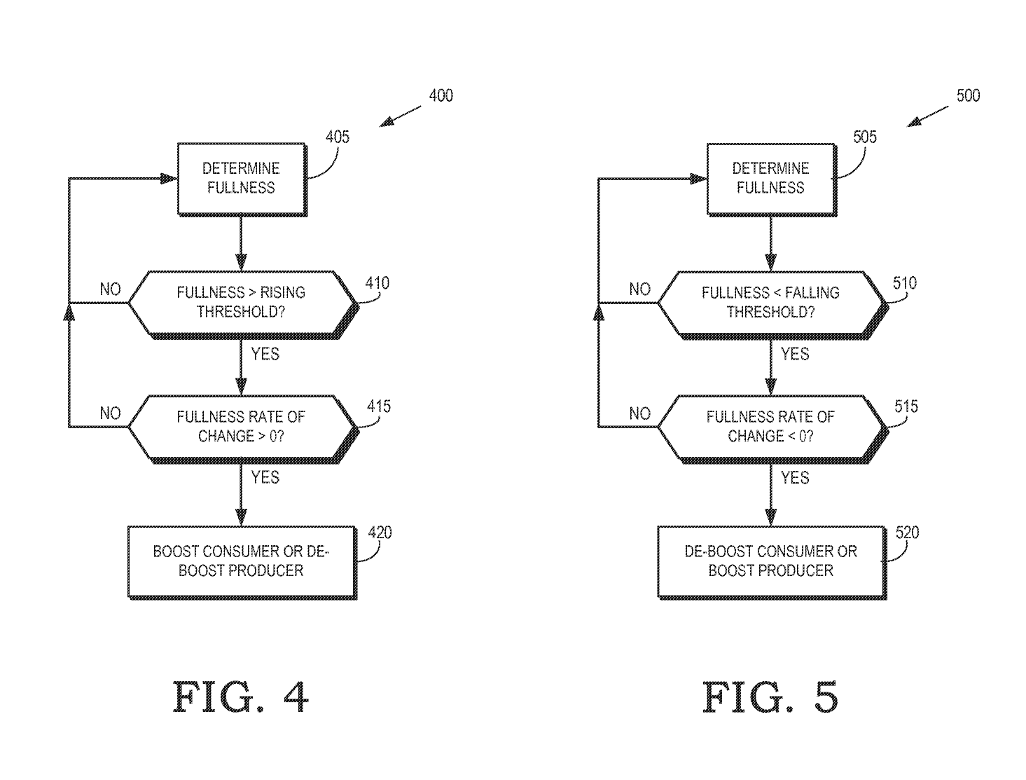

FIG. 4 is a flow diagram of a method 400 that may be used to avert overflow of a queue between a consuming processor unit in a first timing domain and a producing processor unit in a second timing domain according to some embodiments. The method may be implemented in a system management unit such as the SMU 150 shown in FIG. 1. At block 405, the SMU determines a fullness of the queue between the consuming processor unit and the producing processor unit. The fullness of the queue may be determined by measuring the fullness or using information reported by the queue to the SMU. At decision block 410, the SMU determines whether the fullness is larger than a rising threshold. For example, the SMU may determine whether the fullness is larger than 75% of the size of the queue. As discussed herein, the rising threshold may be predetermined or may be dynamically determined based on information such as the rate of change of the fullness of the queue.

As long as the fullness is less than the rising threshold, the SMU continues to monitor the fullness of the queue at block 405. If the fullness is larger than the rising threshold, the SMU determines, at decision block 415, whether the rate of change of the fullness is greater than zero, i.e. positive. If not, and the negative rate of change of the fullness indicates that the fullness of the queue is decreasing, the SMU may decide that there is little danger that the queue is going to overflow and so the SMU may continue to monitor the fullness of the queue at block 405. If the rate of change of the fullness is positive, which indicates that the fullness of the queue is continuing to increase and there is a likelihood that the queue is going to overflow, the SMU may take actions to decrease the fullness of the queue or the rate of change of the fullness of the queue. Some embodiments may use threshold values of the rate of change of the fullness that are different than zero. For example, the SMU may take actions to decrease the fullness of the queue or the rate of change of the fullness of the queue if the rate of change is greater than a positive non-zero threshold value.

At block 420, the SMU may boost the consumer or de-boost the producer. For example, the SMU may boost the consumer by increasing the operating voltage supplied to the consuming processor unit to increase the consumption rate of data produced by the producing processor unit. For another example, the SMU may de-boost the producer by decreasing the operating voltage supplied to the producing processor unit to decrease the production rate of data provided to the queue by the producing processor unit. As discussed herein, some embodiments of the SMU may use a combination of boosting and de-boosting to reduce the fullness of the queue or the rate of change of the fullness of the queue. Examples of these processes are depicted in FIG. 2 and FIG. 3.

FIG. 5 is a flow diagram of a method 500 that may be used to avert underflow of a queue between a consuming processor unit in a first timing domain and a producing processor unit in a second timing domain according to some embodiments. The method may be implemented in a system management unit such as the SMU 150 shown in FIG. 1. At block 505, the SMU determines a fullness of the queue between the consuming processor unit and the producing processor unit. The fullness of the queue may be determined by measuring the fullness or using information reported by the queue to the SMU. At decision block 510, the SMU determines whether the fullness is smaller than a falling threshold. For example, the SMU may determine whether the fullness is smaller than 25% of the size of the queue. As discussed herein, the falling threshold may be predetermined or may be dynamically determined based on information such as the rate of change of the fullness of the queue.

As long as the fullness is larger than the falling threshold, the SMU continues to monitor the fullness of the queue at block 505. If the fullness is smaller than the falling threshold, the SMU determines, at decision block 515, whether the rate of change of the fullness is less than zero, i.e. negative. If not, and the positive rate of change of the fullness indicates that the fullness of the queue is increasing, the SMU may decide that there is little danger that the queue is going to underflow and so the SMU may continue to monitor the fullness of the queue at block 505. If the rate of change of the fullness is negative, which indicates that the fullness of the queue is continuing to decrease and there is a likelihood that the queue is going to underflow, the SMU may take actions to increase the fullness of the queue or the rate of change of the fullness of the queue. Some embodiments may use threshold values of the rate of change of the fullness that are different than zero. For example, the SMU may take actions to increase the fullness of the queue or the rate of change of the fullness of the queue if the rate of change is less than a negative non-zero threshold value.

At block 520, the SMU may de-boost the consumer or boost the producer. For example, the SMU may de-boost the consumer by decreasing the operating voltage supplied to the consuming processor unit to decrease the consumption rate of data produced by the producing processor unit. For another example, the SMU may boost the producer by increasing the operating voltage supplied to the producing processor unit to increase the production rate of data provided to the queue by the producing processor unit. As discussed herein, some embodiments of the SMU may use a combination of boosting and de-boosting to increase the fullness of the queue or the rate of change of the fullness of the queue. Examples of these processes are depicted in FIG. 2 and FIG. 3.

In some embodiments, the apparatus and techniques described above are implemented in a system comprising one or more integrated circuit (IC) devices (also referred to as integrated circuit packages or microchips), such as the buffer circuitry described above with reference to FIGS. 1-5. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

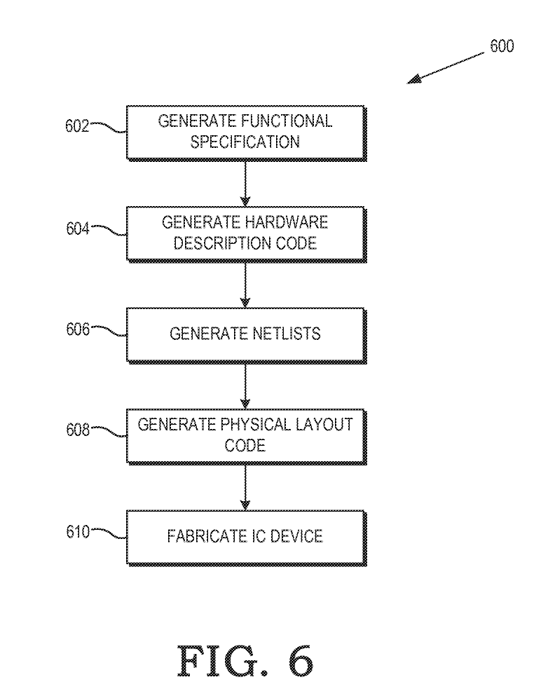

FIG. 6 is a flow diagram illustrating an example method 600 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
modifying at least one of an operating frequency and an operating voltage of at least one of a producing processor unit in a first timing domain and a consuming processor unit in a second timing domain that is asynchronous with the first timing domain based on a rate of change of a fullness of a queue that conveys data between the producing processor unit and the consuming processor unit.

2. The method of claim 1, wherein modifying the at least one of the operating frequency and the operating voltage comprises at least one of:
increasing at least one of the operating frequency and the operating voltage of the consuming processor unit in response to the fullness being greater than a threshold and the rate of change of the fullness being greater than zero; and
decreasing at least one of the operating frequency and the operating voltage of the producing processor unit in response to the fullness being greater than the threshold and the rate of change of the fullness being greater than zero.

3. The method of claim 2, further comprising:
determining the threshold based on the rate of change of the fullness.

4. The method of claim 2, wherein modifying the at least one of the operating frequency and the operating voltage comprises maintaining the at least one of the operating frequency and the operating voltage of the producing processor unit and the consuming processor unit in response to the rate of change of the fullness being less than zero.

5. The method of claim 1, wherein modifying the at least one of the operating frequency and the operating voltage comprises at least one of:
decreasing at least one of the operating frequency and the operating voltage of the consuming processor unit in response to the fullness being less than a threshold and the rate of change of the fullness being less than zero; and
increasing at least one of the operating frequency and the operating voltage of the producing processor unit in response to the fullness being less than the threshold and the rate of change of the fullness being less than zero.

6. The method of claim 5, further comprising:
determining the threshold based on the rate of change of the fullness.

7. The method of claim 5, wherein modifying the at least one of the operating frequency and the operating voltage comprises maintaining at least one of the operating frequency and the operating voltage of the consuming processor unit and the producing processor unit in response to the rate of change of the fullness becoming greater than zero.

8. The method of claim 1, wherein modifying the at least one of the operating frequency and the operating voltage comprises modifying the at least one of the operating frequency and the operating voltage by an amount determined by the rate of change of the fullness.

9. An apparatus comprising:
at least one queue to convey data between a producing processor unit in a first timing domain and a consuming processor unit in a second timing domain that is asynchronous with the first timing domain; and
a system management unit to modify at least one of an operating frequency and an operating voltage of at least one of the producing processor unit and the consuming processor unit based on a rate of change of a fullness of the at least one queue.

10. The apparatus of claim 9, wherein the system management unit is to perform at least one of:
increasing at least one of the operating frequency and the operating voltage of the consuming processor unit in response to the fullness being greater than a threshold and the rate of change of the fullness being greater than zero; and
decreasing at least one of the operating frequency and the operating voltage of the producing processor unit in response to the fullness being greater than the threshold and the rate of change of the fullness being greater than zero.

11. The apparatus of claim 10, wherein the system management unit is to determine the threshold based on the rate of change of the fullness.

12. The apparatus of claim 10, wherein the system management unit is to maintain the at least one of the operating frequency and the operating voltage of the producing processor unit and the consuming processor unit in response to the rate of change of the fullness being less than zero.

13. The apparatus of claim 9, wherein the system management unit is to perform at least one of:
decreasing at least one of the operating frequency and the operating voltage of the consuming processor unit in response to the fullness being less than a threshold and the rate of change of the fullness being less than zero; and
increasing at least one of the operating frequency and the operating voltage of the producing processor unit in response to the fullness being less than the threshold and the rate of change of the fullness being less than zero.

14. The apparatus of claim 13, wherein the system management unit is to determine the threshold based on the rate of change of the fullness.

15. The apparatus of claim 13, wherein the system management unit is to maintain at least one of the operating frequency and the operating voltage of the consuming processor unit and the producing processor unit in response to the rate of change of the fullness becoming greater than zero.

16. The apparatus of claim 9, wherein the system management unit is to modify the at least one of the operating frequency and the operating voltage by an amount determined by the rate of change of the fullness.

17. A non-transitory computer readable medium embodying a set of executable instructions, the set of executable instructions to manipulate at least one processor to:
modify at least one of an operating frequency and an operating voltage of at least one of a producing processor unit in a first timing domain and a consuming processor unit in a second timing domain that is asynchronous with the first timing domain based on a rate of change of a fullness of a queue that conveys data between the producing processor unit and the consuming processor unit.

18. The non-transitory computer readable medium of claim 17, wherein the set of executable instructions is to manipulate the at least one processor to perform at least one of:
increasing at least one of the operating frequency and the operating voltage of the consuming processor unit in response to the fullness being greater than a threshold and the rate of change of the fullness being greater than zero; and
decreasing at least one of the operating frequency and the operating voltage of the producing processor unit in response to the fullness being greater than the threshold and the rate of change of the fullness being greater than zero.

19. The non-transitory computer readable medium of claim 17, wherein the set of executable instructions is to manipulate the at least one processor to perform at least one of:
decreasing at least one of the operating frequency and the operating voltage of the consuming processor unit in response to the fullness being less than a threshold and the rate of change of the fullness being less than zero; and
increasing at least one of the operating frequency and the operating voltage of the producing processor unit in response to the fullness being less than the threshold and the rate of change of the fullness being less than zero.

20. The non-transitory computer readable medium of claim 17, wherein the set of executable instructions is to manipulate the at least one processor to modify the at least one of the operating frequency and the operating voltage by an amount determined by the rate of change of the fullness.
